(19) United States
(12) Patent Application Publication
(10) Pub. No.: US 2009/0271873 A1
(43) Pub. Date: Oct. 29, 2009

(54) METHOD AND SYSTEM FOR DISPLAYING A SEQUENCE OF MEDIA FILES

(76) Inventors: Alon RAM, Fresh Meadows, NY (US); Avraham BAR-YEHUDA, Great Neck, NY (US)

Correspondence Address: Pearl Cohen Zedek Latzer, LLP, 1500 Broadway, 12th Floor, New York, NY, 10036, US

(21) Appl. No.: 12/108,673

(22) Filed: Apr. 24, 2008

(51) Int. Cl. H04L 9/32; G06F 15/16

(52) U.S. Cl. 726/29; 709/202

(57) ABSTRACT

A server connected to a network may receive a media file and divide the media file into one or more display files according to the number of display components in the media file. The display files may be stored in a media storage library on the server. An image display sequence including an order list of one or more selected display files stored in the media storage library may be generated. The server may authenticate a display client configured for viewing a sequence of images on the server and transmit to the display client a pointer to the image in the sequence of images to present.

### FIELD OF THE INVENTION

The present invention relates to methods and systems for displaying files or series of images or files, such as presentations.

### BACKGROUND OF THE INVENTION

The success of the Internet as a medium for business communications has fueled a growth in the number and types of Internet or web-based business tools. One area that has seen increased attention is the use of the Internet to share or present media files with one or more viewers.

Internet-based conferencing products exist that allow a controller or presenter to connect with one or more viewers and show them what is visible on the presenting computer's screen. These systems typically operate via Internet browsers, and require presenters and viewers to install a specialized or proprietary plug-in application, beyond an Internet or web browser, from for example a conferencing service in addition to freely distributed plug-in applications that may be needed for viewing media files of various formats.

Other systems may enable the controller or presenter to display the contents of a presentation without showing the entire contents of what is visible on the controlling computer's screen. This may be achieved for example with a specially designed plug-in application for both the controller's and the viewer's browser, beyond software such as word processing of graphic display software commonly installed or pre-installed on a computer. Such a system may require the controller to upload the entire media file being presented to a server in advance of the presentation.

### DESCRIPTION OF THE DRAWINGS

Specific embodiments of the present invention will be described with reference to the following drawings, wherein:

FIG. 1 is a simplified block diagram of a system for displaying a sequence of media files in accordance with an embodiment of the invention.

FIG. 2 is a simplified software block diagram of a server for displaying a sequence of images in accordance with an embodiment of the invention.

FIG. 3 is an illustration of a user interface for controlling the display of a sequence of images in accordance with an embodiment of the invention.

FIG. 4 is a simplified software block diagram of components in a system for displaying images in accordance with an embodiment of the invention.

FIG. 5 is a flowchart showing a method for assembling a sequence of images in accordance with an embodiment of the invention.

FIG. 6 is a flowchart showing a method for displaying a sequence of images in accordance with an embodiment of the invention.

### SUMMARY

A method and system may, in one embodiment, at a server connected to a network, receive a media file including one or more display files according to for example the number of display components in the media file. The display files may be stored in a media storage library on the server. A file display sequence including an order list of one or more selected display files stored in the media storage library may be generated. The server may authenticate a display client configured for displaying a sequence of images on the server and transmit to the display client a pointer to the image in the sequence of images to present.

### DETAILED DESCRIPTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

When used herein, a media file may include, for example, a presentation file such as those in the Microsoft PowerPoint® format or other formats which may or may not be animated, a document such as those in the Microsoft Word® or WordPerfect™ format or other formats, a video file such as those in an .avi, .mpg or other format, an audio file such as those in a .wav or other format, images such as those in a .jpg, .gif or other format, and other types of media files

When used herein, a display file or presentation item may be any file that may be embedded and displayed in a web browser without installation of additional software such as for example activeX components or special format unique plugins. A display file may include, for example, any file containing an individual image or page including but not limited to a photographic or other graphical image, a single slide, page or chart of a presentation, a single page of a text document, a single page of a spreadsheet and other types of individual image forms. Display files may also be video, audio, or animation files such as for example those in the Macromedia Flash® format, and other formats. Display files may be derived from for example Microsoft PowerPoint® format or other formats, a document such as those in the Microsoft Word® or WordPerfect™ format or other formats, a video file such as those in an .avi, .mpg or other format, an audio file such as those in a .wav or other format, images such as those in a .jpg, .gif or other format, and other types of media files. Furthermore, the file format of a display file may be dependent on the type of image and/or other content type contained in the file. The display file format may also depend on compatibility with one or more web browsers such as for example Microsoft Internet Explorer.

Embodiments of the present invention include a system and method for displaying to a viewer or recipient a sequence of images stored for example as display files on an Internet or web server. The presentation may be dynamic and allow for spontaneous action or changes on the part of the presenter. As opposed to systems which restrict the presenter to a fixed sequence, some embodiments of the present invention may allow for the presenter to alter the order of files and/or images presented to a viewer or to introduce new images into the sequence, during the viewing of the sequence by the user.

In one embodiment, an Internet or web server may host a web site providing separate links or references such as hyperlinks to each display file. The code operating the web site may be written in for example a formatting language such HTML and accessible via HTTP; other languages may be used.

The display on one or more viewer terminals may be controlled from a client workstation or control terminal operated by a user or presenter. In some embodiments, a server may provide two or more distinct web pages—one web page for displaying the sequence of images to a viewer and one web page for allowing a presenter to control the displayed sequence. A presenter or other user located remotely from the server may view a first web page and a viewer may view a second web page. The presenter may use an interface presented in the first web page possibly referred to as a control page to control the content displayed in the second web page possibly referred to as a display page.

A presenter or other user located remotely from the web server and operating a control terminal, for example a file schedule controller, may determine what display files to display and their sequence. The presenter at the file schedule controller may access the web site with a software application such as a web browser or other user agent for interacting with a web site and may direct or manage the sequence using for example a control page on the web site.

A user at a viewer terminal may access the images using for example a software application such as web browser or other user agent for displaying on a viewer terminal the contents of a web site. In some embodiments, when downloaded to a browser an image in the display page of the web site may fill the browser's viewing area.

In some embodiments, a viewer terminal may send a request to the server for transmission of a current pointer or link to the current display file (which may in some embodiments point to or reference a page of a presentation). This request may be implemented for example by a script on the display page that is executed by the web browser on the viewer terminal. A pointer such as a Uniform Resource Locator (URL), hyperlink, or hypertext transfer protocol HTTP) link to one of a sequence of display files may be passed to the viewer terminal client (e.g., a browser). If a new image is to be displayed, or if the image to be displayed has changed, the pointer or link will have changed from the previous pointer or link. The browser on the viewer terminal may access the file for display for example via such a link to a remote file without an action required from the viewer and possibly without any other change to the web page being displayed. Furthermore, the links to the images may not be visible to the viewer—the browser may use different links to access different images for display while the browser displays to the viewer the same display URL. Such links to files for display may be stored internally to the browser, and not displayed to the user. Except for normal Internet browser functions, a file may not be downloaded to the viewer computer in a form easily allowing saving or accessing after the image or page is no longer viewed.

In some embodiments, the request for a pointer or reference to the current display file may be made, for example, periodically or at a regular interval; the period may change according to system needs and loads. Each file of the sequence may be accessed by for example a link to the display file on the web site. One or more viewers may thus be presented (e.g., on a display page of a web site) with a sequence of images from the web site, for example a presentation, by the presenter. The presenter may, through the control page, manage or control which files or images are displayed to the viewers and when they are viewed. The presenter may in addition communicate with the viewers via audio and/or video, e.g., via teleconference or videoconference, which may be conducted via the server or via another channel. Alternatively, the presenters may communicate with viewers via for example a text chatting or instant messaging system or another method.

Typically, one display file or image is shown to a viewer or recipient at one time, the image or page possibly filling the viewing area of for example an Internet browser on the viewer's computer. The process may occur or may be fast enough to be perceived to occur in real-time: the presenter may select a file to display and that page may be viewed more or less immediately by a recipient.

In some cases, a media file may contain one or more display files in a browser compatible format. In other cases, it may be necessary to reformat the images contained in a media file of a standard format such as Microsoft Word® or PowerPoint® for display. For these media files, a software agent on the web server may break or divide the file into multiple display files, display components, or pages where each separate display file may correspond to for example a different slide from a presentation or page from a document. These display files may also include multiple copies of the same image at two or more different graphics resolutions. Alternatively, the same image may be stored separately in two or more display files each including the same image at a different graphic resolution for compatibility with different screen sizes and/or resolutions for various viewers.

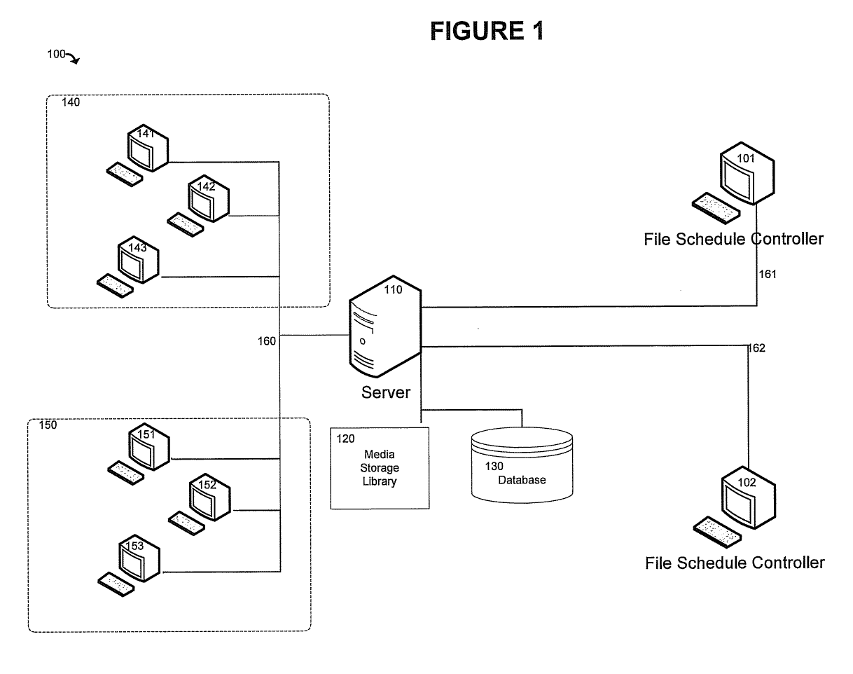

FIG. 1 is a simplified block diagram of a system for displaying a sequence of images in accordance with an embodiment of the present invention. System 100 may include file schedule controllers 101 and 102, typically operated by a presenter to control the output viewed by a viewer or recipient, server 110 for hosting or executing a system or service for displaying a sequence of images, an associated media storage library 120 and an associated database 130, viewer terminal group 140 including viewer terminals 141, 142, and 143, and viewer terminal group 150 including viewer terminals 151, 152, and 153. As an example only, two viewer terminal groups and six viewer terminals are shown, and two file schedule controllers are shown, but other numbers may be used. Viewer terminal groups 140 and 150 may be connected to server 110 via a network 160, which may be a public network such as for example the Internet. Similarly, file schedule controllers 101 and 102 may be connected to server 110 via networks 161 and 162 respectively. Networks 160, 161 and 162 may be the same network such as a public network such as the Internet. File schedule controllers 101 and 102 may be remote from and separate from terminal groups 140 and 150.

File schedule controllers 101 and 102 may be used by a presenter such as for example a presenter or user who is creating a presentation for display or who is giving, or administering a presentation remotely or remotely controlling the display of a collection of images or display files during a display session to one or more viewers sitting for example at viewer terminals 141-143 simultaneously. Furthermore, the presenter may communicate with the viewers in a one-way or two way audio or video channel such as for example by a conference call managed by server 110, voice over internet protocol (VOIP) service, or a device separate from server 110. File schedule controllers 101 and 102 may be or include any general purpose computer capable of supporting an application for interfacing with server 110 to control the configuration of a sequence of images and to upload media files to server 110. Such general purpose computers may include for example a personal computer or other computer, or any other suitable device such as a cellular phone, personal digital assistant (PDA), video game console, etc. Although not limited in this respect, some embodiments of the present invention may incorporate for example an Internet or web browser as an application for interfacing with server 110 such as for example Internet Explorer®, Firefox®, Netscape®, Opera©, or Safari®. Such web browsers are commonly installed (or easily installed) on computing devices, and may retrieve content from the Internet using a client-server dialogue including requests from the browser and responses from a web site or other server. Such web browsers may work in concert with other commonly installed or pre-installed applications such as PowerPoint®, Adobe® Reader®, or Microsoft Word®, possibly with the installation of the commonly distributed corresponding plug-ins that are integrated into or used with the web browsers when installed. Some embodiments of the invention may not require these plug-ins for showing display files derived from or used with these applications. File schedule controller 101 may differ from file schedule controller 102 only in that file schedule controller 101 may be used to create or control a different sequence of images than file schedule controller 102.

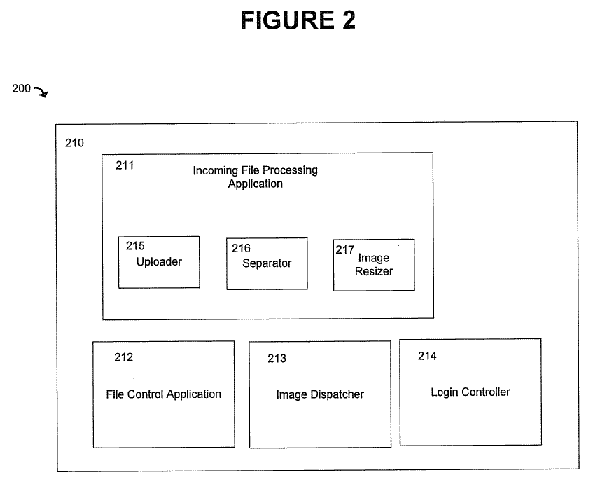

Server 110 may serve as the host for an application or applications that enable a presenter at a separate computer such as file schedule controller 101 to display a presentation or sequence of images to viewers via network 160. Server 110 may be or include any computer capable of hosting a process as disclosed herein, and applications for executing a system or service for displaying a sequence of media files. Media storage library 120 may be or include any system or device capable of storing media files and/or display files such as for example a disk drive, database, or other memory device. Database 130 may be or include any software process or application for storing and retrieving information, files, or a plurality of documents, such as a database system such as, e.g., a relational database. Items stored in database 130 may include for example display file sequences for display and associated data, files, presentations, user data, and authentication data. It will be appreciated by those skilled in the art that one or more of server 110, media storage library 120 and database 130 may be combined or separated into one or more physical units or software modules able to perform separately or together functions of the units shown in the embodiment of FIG. 2. Other or additional components may be included.

Viewer terminal group 140 may be a group of terminals used by people viewing files stored, presented and controlled by file schedule controller 101 and 102 and server 110, which may be displaying the image on server 110 (in some cases the group may include one terminal). Viewer terminal group 150 may differ from viewer terminal group 140 only in that the terminals in viewer terminal group 150 may be displaying a different image that is stored on server 110. Viewer terminals 141-143 and 151-153 may be any general purpose computers capable of supporting an application for retrieving and viewing web content, such as a personal computer, or any other suitable device such as a cellular phone, personal digital assistant (PDA), video game console, etc. Although not limited in this respect, some embodiments of the present invention may incorporate a web browser as an application for retrieving and viewing web content, or for example for displaying sequences of images for viewers or creating, controlling and uploading sequences of display files for presenters. Such web browsers may retrieve content via network 160 in a client-server dialogue of requests from the browser and responses from the web site.

Network 160, which connects server 110 and viewer terminals 141-143 and 151-153, and networks 161 and 162 may be any local network or publicly accessible network such as the Internet; they may be the same network (e.g., the Internet), or may be a combination of networks. Access to networks 160, 161, and 162 may be through wire line, terrestrial wireless, satellite or other systems well known in the art.

Reference is now made to FIG. 2, which is a simplified block diagram of a server 210 for displaying a sequence of images in accordance with some embodiments of the present invention. Server 210 may include for example an incoming file processing application 211, a file control application 212, an image dispatcher 213, and a login controller 214. Although operations are assigned to the different components of server 210 as these entities are described herein, in other embodiments the operations may be performed by different entities, having different structures.

Incoming file processing application 211 may be any software process or application capable of receiving an uploaded media file in one or more different formats such as for example Microsoft PowerPoint™, Microsoft Word™, or Microsoft Visio™ and separating or dividing the media file into one or more smaller display files such that each smaller file includes one individually viewable element or image such as for example a single presentation page or chart. Incoming file processing application 211 may include components such as for example uploader 215, separator 216, and image resizer 217. In some embodiments, uploader 215 of incoming file processing application 211 may determine if the received file is already an individual display file or if it is a media file that requires extraction of one or more images contained therein. Different components of incoming file processing application 211 such as separator 216 may be assigned by uploader 215 to separate or extract the display files from the media file according to the different formats of the incoming media files.

Display files may be resized or reproduced in multiple size formats to conform to different display sizes on different viewer terminals by for example image resizer 217. Incoming file processing application 211 may also include a file name generator that may assign names to each of the files that may have been extracted from a single media file and resized according for example to a file naming convention as known in the art. In some embodiments, the file names for the display files may be related to the original file name. In some embodiments, the display file format may also be dependent on the format of original media file from which they are extracted.

Incoming file processing application 211 may also be capable of storing the extracted or separated display files in media storage library 120 or other image bank with a corresponding entry in database 130. The entry for a display file may include one or more file attributes such as for example the file name, the file type or format, file size, the file owner or sender, file access rights, and other type of file attributes.

File control application 212 may be any software process or application such as for example a process generating a web page with user controls or other web application capable of receiving requests from for example file schedule controller 101 or other such workstation or computer on an associated network such as network 161 with access to file control application 212 on server 110. The requests may include for example requests for transmission of one or more pointers to files or images for display on the file schedule controller. Such images may be used in determining a sequence of display files for subsequent display on viewer terminals. Additionally, file control application 212 may be capable of receiving instructions from file schedule controller 101. These instructions may include for example directions for assembling an ordered list or sequence of one or more media files stored in media storage library 120, for displaying in-order or out-of-order a specific file or page, or for uploading, after the initial uploading of a media file, a file for viewing by viewers. The ordered list or sequence may include for example the entry number on the list, the name of the file, the file owner, file access rights, and or other or different file attributes associated with the display files on the ordered list. In some embodiments, file control application 212 may store the ordered list in for example tabular form or other list form in database 130. A presenter operating file schedule controller 101 may direct that specific files in the list be displayed at specific times, and the display may not be “in-order.”

Image dispatcher 213 may be any software process or application capable of directing access to a file or image for display on viewer terminals such as for example viewer terminals 141-143 or 151-153 on network 160. Image dispatcher 213 may direct access to an image by fulfilling a request from a process on a viewer terminal for a current pointer to a display file. Image dispatcher 213 may fulfill the request by, for example, querying database 130 for the current display file using a unique token or session identifier that identifies the specific presentation being displayed on the viewer terminal

The current display file or page may be indicated by for example a link, server pointer or other reference to a single image or entry in the ordered list of images. An internal server pointer stored at a server may be different from a pointer or link, stored at or generated by the server, which allows a process such as an Internet browser at viewer terminal to access the image or page. However the two pointers may refer to the same display file, e.g. a page or an image; the pointer sent to the browser may be of the type allowing for viewing of images via the internet, such as a URL, but the server pointer may be, e.g., a number, a slide name, etc. In some embodiments the pointer may be identical. Other techniques for directing a request for a current pointer to the current display file may also be used.

To create a presentation or sequence of images, a presenter or user at a file schedule controller may upload one or more media file(s) such as a presentation file to server 110. Incoming file processing application 211 may divide or split the presentation file into one or more individual display files corresponding to the number of pages or similar divisions in the presentation file. In one embodiment, the file is split into a series of views or images, each view or image corresponding to one page viewed during a presentation. Other methods or software for splitting the file may also be used. File processing application 211 may also name and save the resulting display files in media storage library 120. A user or presenter may refine the split or division, or perform the split.

The presenter can then select which display files to include and in what order or sequence. The presenter may use file control application 212 to save this sequence in database 130.

Login controller 214 may be any software process or application capable of granting or denying access for presenters and for viewers to a presentation session. Methods of granting or denying access to applications or data resident on servers or applications are well known and may include for example a presenter or viewer submitting a user name and password to login controller 214 for authentication. Other methods may also be used. In some embodiments, login controller 214 may also be capable of collecting client information, e.g. from a viewer terminal or file schedule controller, such as for example screen resolution, browser type, operating system type, and storing this information in for example database 130. Login controller 214 may further be capable of determining which presentation to which a viewer may be granted access for viewing, assigning a unique token corresponding to the presentation and the viewer, providing this token to the viewer, and storing the token in for example database 130. As used herein, the granting or denying access; the collection of client information; and the assigning, providing, and storing the token may all be parts of the login process for a viewer of a presentation.

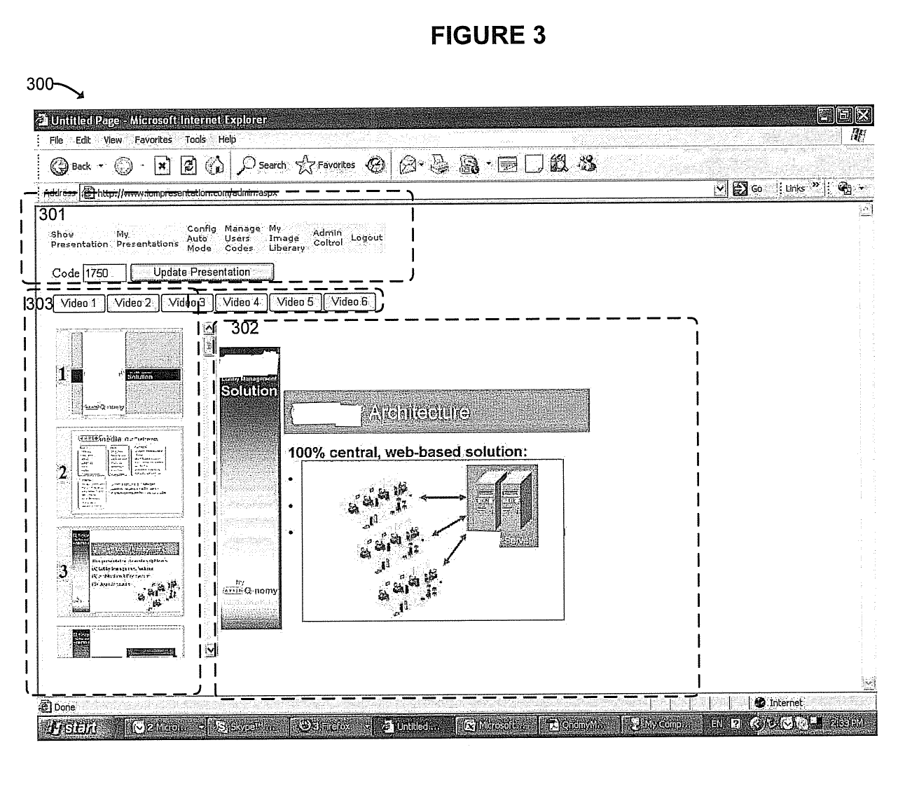

Reference is now made to FIG. 3 which is an illustration of a user interface 300 for controlling the display of a sequence of images in accordance with an embodiment of the invention. User interface 300 may be implemented for example as a web page on a web site hosted by server 110. File schedule controller 101 may display user interface 300 to a user or presenter with a web browser without any plug-ins or other specialized software. File control application 212 may respond to a presenter's commands as input through user interface 300.

User interface 300 may include for example a set of user controls 301, a current image display 302, and a presentation sequence 303. Other display functions may also be implemented. User controls 301 may include controls needed for assembling and displaying a sequence of images such as for example, a show presentation command, a command for listing existing presentations, a display file library listing, administrative controls, logging functions, access to video files for display, and saving a presentation sequence. Additional or alternative controls or commands may be implemented. Further, commands may be displayed as buttons, menu functions, or with other such command display techniques known in the art.

Current image display 302 may show the presenter what display file or image is currently being displayed to the presenter. Additionally, current image display 302 may indicate which display file is being edited for presentation by the presenter. Other uses for current image display 302 may also be implemented.

Presentation sequence 303 may display to the presenter one or more of the images from the display files currently included in a display sequence. Although the embodiment of FIG. 3 shows three images in presentation sequence 303 arranged vertically as well a number of video display files which may be accessed or used for example using controls or buttons arranged horizontally, other numbers of images and arrangements of images such as for example horizontally may be used; other indicators of display files; other methods of functionality for a presenter may be implemented, and other user interface functionality may be implemented. Presentation sequence 303 may also include navigation functions such as for example a scroll bar for moving among the images displayed. Other control functions such as a select image or drag and drop image function may also be included.

When a viewer at for example viewer terminal 141 logs in to server 110 and is directed to the display (web) page, the presenter may start the presentation by selecting the first display file for display as the current image. A software application such as for example a browser on viewer terminal 141 may (possibly after a login or authentication procedures) begin periodically and possibly regularly requesting the currently displayed image from server 110 as directed by for example a script on the display web page. Each time the presenter changes the current image (e.g., display file), a subsequent request for the current pointer or reference from viewer terminal 141 will result in the server transmitting the new current display file to viewer terminal 141. The presenter's changing the display file and the viewer terminal's requesting a current pointer may continue until the presenter is finished with the presentation.

An advantage of embodiments of the present invention may include that the contents of a user or presenter screen may differ from what is displayed at a viewer terminal. By allowing viewer terminals to display only the current image designated by the presenter, a presenter is able to make changes to an image or to perform tasks such as search for a slide or image, and show only the final version of the slide to viewers.

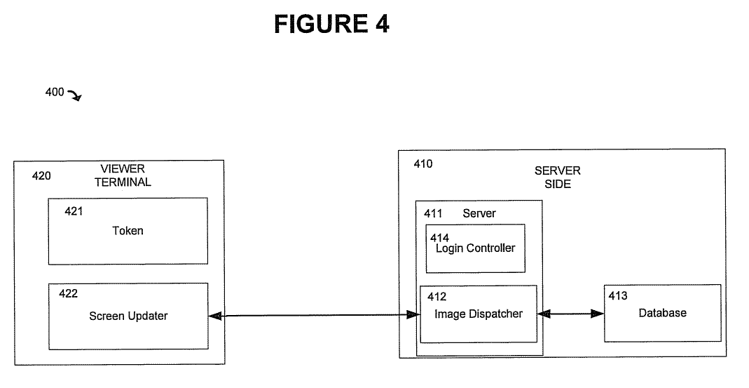

Reference is now made to FIG. 4 which is a simplified block diagram of components of a system for displaying images with an authentication system in accordance with an embodiment of the invention. System 400 may include a set of server side components 410 and a viewer terminal 420 that may be for example identical to viewer terminals 141-143 or 151-153. The server side components 410 may include a server 411 which may for example be identical to server 210 and may be connected to a database 413 that may for example be identical to database. Server 411 may include image dispatcher 412 for transmitting display files to viewer terminal 420 and a login controller 414 for logging in users. In some embodiments, image dispatcher 412 may be for example identical to image dispatcher 213 and may have access to network 160. Alternatively, image dispatcher 412 may be a distinct component associated with server 411 while having access to network 160 either separately or through server 411. Similarly, login controller 414 may be for example to login controller 214 and, alternatively, be a distinct component associated with server 411.

Image dispatcher 412 may use network 160 to communicate with a screen updater 422 in viewer terminal 420. Screen updater 422 may be a web browser, applet or other component in a web browser, or other software application which may retrieve images from image dispatcher 412 and which may for example run a program such as a script embedded on the display page for requesting the current image. Viewer terminal 420 may also include a pointer or token 421 which may be generated by login controller 414, sent to viewer terminal 420, and stored in memory such as for example random access memory or on a hard drive. Screen updater 422 or another component of terminal 420 may include an internal pointer such as a URL to the current image (file) being displayed; in one embodiment this pointer is different from the URL seen by the viewer in the browser being operated by terminal 420.

In some embodiments, the token 421 may be for example a label, pointer, string or any combination of characters generated during an authentication portion of a viewer's login process stored on the viewer's terminal that may identify, possibly uniquely, the viewer or viewer terminal during a session and may provide the server with a means of uniquely identifying the viewer requesting a current pointer. The identification need not be unique to a viewer; for example token 421 may identify a presentation to be shown. A viewer may log in to the system using a viewer terminal 420. Using an authentication method as known in the art, login controller 414 or other element of server side components 410 may authenticate the viewer. Once a viewer is authenticated, login controller 414 may receive terminal information from viewer terminal 420 including, but not limited screen size or resolution, operating system, and browser type. This information may be stored in for example database 413. Login controller 414 may send token 421 to viewer terminal 420 for storage and subsequent use during the display session to identify viewer terminal 420 as being associated with a particular presentation session.

In some embodiments, screen updater 422 may send token 421 to image dispatcher 412 as part of a request to update the image for display on viewer terminal 420. The frequency of these requests may be regulated by image dispatcher 412 or other server side component 410 not shown and may depend on the activity level of server side components 410, the number of viewers accessing the server for display sequences, or other loading or other performance parameter. For example, if the server side components are not busy, updates may be requested every two seconds and every four seconds during very active periods. Other rates may be used.

Token 421 may act as an identifier for viewer terminal 420 to image dispatcher 412. During an file pointer request update, image dispatcher 412 may use token 421 to query database 413 as to which image (file) is currently being displayed for the display sequence being shown at viewer terminal 420. Because database 413 may include terminal display information of viewer terminal 420 collected for example during login, image dispatcher 412 may return a reference to a display file in a screen resolution or format compatible in particular with viewer terminal 420.

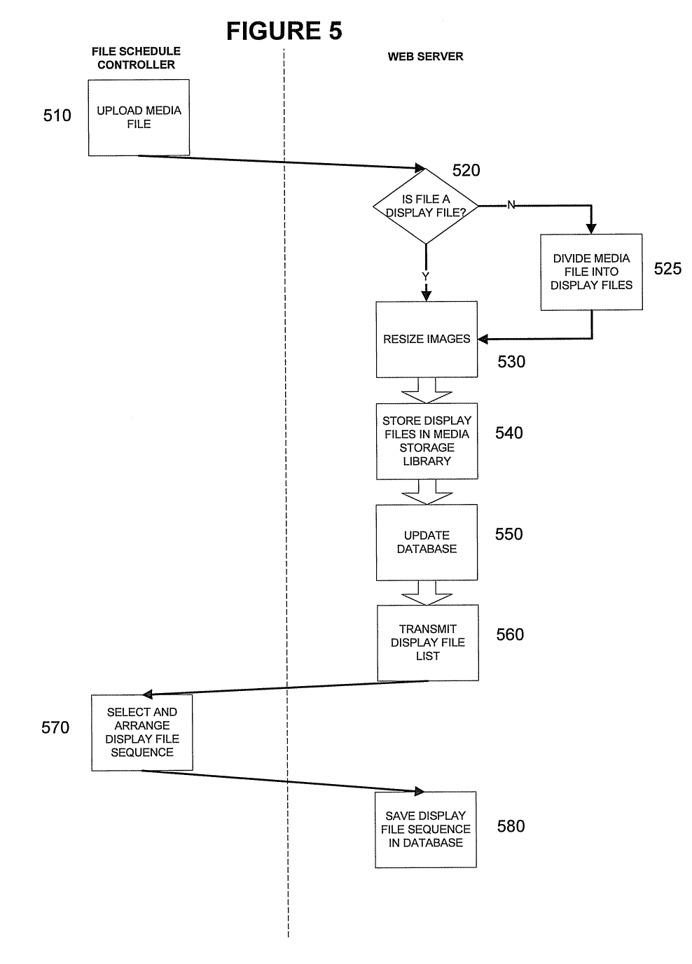

Reference is now made to FIG. 5, which is a flowchart illustration of a method for assembling a sequence of images in accordance with some embodiments of the present invention. While operations are assigned to a file schedule controller such as file schedule controller 101 and a server such as server 110 as these entities are described herein, in other embodiments the operations may be performed by different entities, having different structures. Furthermore, other or different operations or sequences may be performed.

A presenter or owner may upload a media file from for example a file schedule controller 101 or 102 to server 110 via network 161 or 162 respectively (operation 510). The presenter may control the file uploading and sequence assembling through a user interface such as user interface 300. At server 110, software such as for example uploader 215 of incoming file processing application 211 may check to see if the incoming file is a display file (operation 520). If the media file is not a display file, separator 216 of incoming file processing application 211 may split the media file into one or more image or other files according to the media file contents or file format (operation 425). For example, if the incoming file is a PowerPoint™ formatted presentation file, a separator component of incoming file processing application 211 for operating on such files may divide the presentation into separate display files. Image resizer 217 of incoming file processing application 211 may resize or reproduce the resulting display files in multiple image sizes or formats to accommodate possible different display graphics resolutions or screen sizes such as for viewer terminals 141-143 and 151-153 (operation 530).

If an incoming file is already a display file, incoming file processing application may proceed with image resizing directly without any separation or extraction. Further, a presenter may divide a file into images.

In some embodiments, incoming file processing application 211 may also assign distinct names to each of the display files derived from the media files. A file naming convention may be used for naming the display files such as for example appending a number to the file name of the media file corresponding to the number of the display file. Other file naming conventions may also be used.

In some embodiments, a presenter may be able to assign access rights to the generated display files. Such rights may be assigned as for example “private use” meaning the presentation owner may be allowing access to only a limited list of presenters and for example “public use” meaning the presentation owner may be allow all presenters to have access. Other types of rights such as for example including viewer restrictions may be used

In operation 540, the display files produced in operation 530 may be stored in media storage library 120 or other storage system capable of storing display files in graphics, audio, video or text form as appropriate to the display files being stored. In operation 550, information about the stored files may be saved in database 130. The information saved for each file in database 130 may include for example file owner or creator, file identification number and/or file name, and image type. In operation 560, a list of file names saved in operation 550 may be transmitted to for example file schedule controller 101. Additionally, in some embodiments other information saved in operation 550 may also be transmitted to file schedule controller 101.

The transmitted list of file names may represent the individual elements available the presenter to create a sequence of images (files) for subsequent display on viewer terminals. Other display files stored previously in media storage library 120 may also be available to the presenter. A presenter may be able to determine what display files are available to the presenter in a media storage library querying process as is known in the art by access rights. In some embodiments, access to display files previously stored in media storage library 120 may be limited such as for example to the presenter who stored the display files on the library or alternatively to presenters with an appropriate authorization level. Other methods of selectively granting access to display files may also be used. Conditional access systems for verifying a presenter's rights of access are known in the art.

In some embodiments, file control application 212 may be used by presenter at a file schedule controller to view each of the display files stored on media storage library 120 via requests received from the file schedule controller using for example a web browser that displays user interface 300. By viewing the display files, a presenter may be able to determine a desired selection of display files and sequence or schedule of the selected files (operation 570). This sequence of files may be represented by an ordered list of for example file names or other appropriate pointers to the display files selected for presentation.

The presenter-created display file sequence may be for example saved in database 130 (operation 580). In some embodiments, file control application 212 may append one or more file attributes of the display files named in the sequence to each of the respective sequential entries. Other methods for including file attributes in the sequence stored in database 130 may also be used.

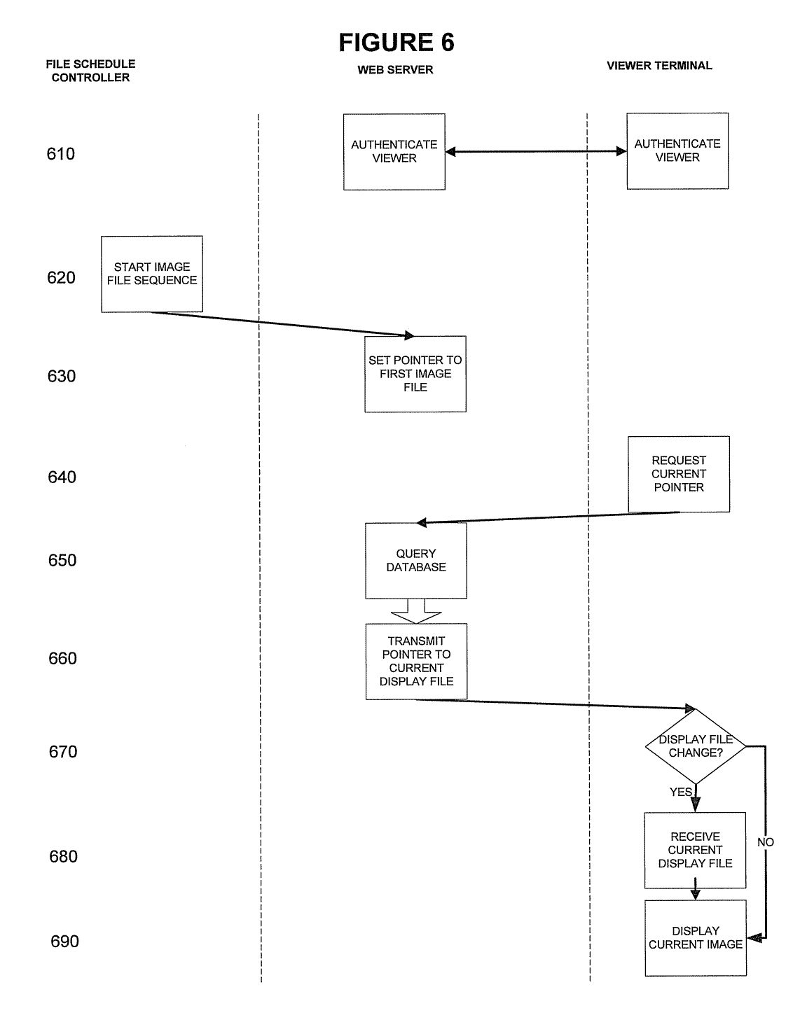

Reference is now made to FIG. 6, which is a flowchart illustration of a method for displaying a sequence of images to one or more viewers in accordance some embodiments of the present invention. Such a sequence of images may be displayed to one or more viewers for example by a presenter or other user at for example file schedule controller 161 as for example a presentation. In some embodiments the presenter may use an interface such as for example user interface 300 to control the presentation, while the viewer may be directed to a display page on a web site hosted by server 110.

While operations are assigned to a file schedule controller such as file schedule controller 101, a server such as server 110, and a viewer terminal such as viewer terminal 141 as these entities are described herein, in other embodiments the operations may be performed by different entities, having different structures. Furthermore, other or different operations may be performed.

A user or presenter may invite or notify viewers of a scheduled or unscheduled presentation in advance of the presentation. The invitation or notification may be communicated by techniques known in the art including but not limited to e-mail with or without a link to a web site for the service, posting a notice of a presentation on a web site associated with the service, text message, and other such communication techniques.

In operation 610, a viewer at for example viewer terminal 141 may connect to or log in to the service on server 110 via network 160. The login process may be managed by for example login controller 214 through an authentication process as is known in the art. Such a process may require a viewer to provide an identification number, presentation key, password, and or other code or identifier that allows login controller 214 to authenticate the viewer. In some embodiments, these identifiers may be permanently assigned to the viewer, and login controller 214 may determine which viewers can be granted access to a specific sequence of images or presentation based on the presenter's instructions. In other embodiments, a one-time password or password with an expiration date or window of validity may be sent in advance to viewers whose access may be limited to a specific sequence or presentation. Other techniques of access control and authorization may also be used.

Once a presenter has logged in, login controller 214 may receive information from viewer terminal 141 such as for example screen resolution, operating system, and browser type. Login controller 214 may assign a unique token and/or session identifier corresponding to the presentation session and may send the token to viewer terminal 141. In a presentation session, viewer terminal 141 may send this token to image dispatcher 213 as part of a request for the pointer to the current display file. Image dispatcher 213 can determine the relevant client properties of viewer terminal 141 by for example querying database 130 with the token and can also determine which file is the current file being displayed for the presentation corresponding to the token Image dispatcher 214 may return a web page url for the current image to viewer terminal 141. In other embodiments, the use of an initial authentication and a later used token identification may be different. For example, the user identification used initially may act later as a token.

In some embodiments, when one or more viewers have logged in to a service provided by an embodiment of the present invention, login controller 214 may send a message to the presenter at file schedule controller 101 via network 161 informing the presenter that one or more viewers have logged in to the service. Alternatively, the login controller 214 may alert the presenter as to viewer status by an out-of-band communication such as by phone or email. Other techniques for informing the presenter of viewer status may also be used.

In operation 620, the presenter at file schedule controller 101 may start the display sequence. Although the display sequence is ordered, the presenter may select any file or image corresponding to a file in the sequence as the first for display.

An indicator of the presenter's selection may be transmitted to file control application 212 via network 161. File control application 212 may set a pointer internal to the server to the display file corresponding to the image selected by the presenter (operation 630). Other methods for indicating the image selected by the presenter may also be used. The pointer used or stored by file control application 212 may be different from the pointer or link used by a viewer terminal to determine which image to display.

In some embodiments, screen updater 422 which may be for example a software process such as a script of the display page being executed in the browser on viewer terminal 141 may on a periodic basis (typically frequent, and possibly regularly) query server 110 as to what file, e.g. image, slide or page is currently being displayed (operation 640). Alternatively, screen updater 422 may be a separate applet or software application downloaded into for example a web browser when the presenter logs in to server 110 or at some other time. In some embodiments, screen updater 422 may not require modification of an existing browser and may not require installation on file schedule controller 101 such as for example, when screen updater 422 is a script embedded in the display page and running on a browser.

Not requiring installation for use of the service may be an advantage of some embodiments of the present invention. Many current technologies require installation of a plug-in such as proprietary and non-standard (and thus not trusted) software, customized for a particular service or other software component for activation. Such installation by presenters may be prohibited in some enterprises or organizations with restrictions on workstation configuration changes.

The request for a pointer or reference to the current display file may include a token or other identifier such as for example token 421 as an identifier of the viewer terminal requesting the current image. The request may be transmitted on network 160 to for example image dispatcher 412 which may query for example database 413 for a pointer to the current image in operation 650.

In operation 660 the server may transmit a reference or pointer such as for example placeholder on the web page being displayed corresponding to the current display file to viewer terminal 141. In some embodiments, this pointer may be a URL or a link to the display file that may not be visible to the viewer at viewer terminal 141. The pointer may be stored, for example, in the code in the viewer terminal, for example in code or a script being operated by a browser. This pointer may be separate from the visible URL or pointer that often appears at the top of a presenter's browser program and which may be the URL of the web page on which the presentation is being shown. The visible URL or pointer may not change, but the web page displayed by the browser, pointed to by the hidden pointer, may change.

Upon receipt of the pointer, viewer terminal 141 may determine if the display file (e.g., an image) being displayed has changed (operation 670). A script being executed by the browser on viewer terminal 141 may make this determination by for example comparing the newly received pointer or link with last one. In one embodiment, a change in the pointer indicates a change in the display file. If the current display file has not changed, the method proceeds to operation 690 which displays the current image.

If the display file has changed, viewer terminal may, in operation 680, receive the new current pointer to the display file and, subsequently, the new display file for example as part of the routine operation of the browser for downloading files on a web page as known in the art. Downloading the current display file using inherent internet browser technology eliminates the need for any action on the part of the viewer and eliminates the need for any added software component, plug-in, or application. Furthermore, the display files may not be saved in an easily accessible part of the viewer's computer. For example the display file may be temporarily stored in a cache file, but not saved in a directory or in a directory easily accessible to the user as if the file itself was transferred to the presenter's computer for more permanent storage. Viewer terminal 141 may then display the current image (operation 690). The process may be perceived to occur in real-time by the viewer: the presenter may select a page to view and that page may be viewed more or less immediately by a recipient.

The process of steps 620 to 690 may be repeated for as many display files as the presenting user chooses to present. In some embodiments, the presenter may set the pointer to any position in the sequence, for example non-sequentially to any display file in the sequence, at any time during the display session. In some embodiments, the presenter may add new display files to the sequence during the display session. The new files may already be stored in media storage library 120 or may be uploaded during the display session and added to media storage library 120 using for example the operations shown in FIG. 4.

Below is simple pseudo-code which may run in the background on the viewer' browser and, in one embodiment, may allow a browser to view display files provided by a server by, for example updating a link to a display file containing an image or page without affecting the web page itself. Further, a change in the file being displayed at the server may not require a page refresh to display a new current file using for example an Asynchronous JavaScript and XML technique as known in the art. In one embodiment the link is a URL which is hidden from the viewer, and does not appear on the viewer's browser. Other code segments, other languages, and other functionality may be implemented. The comments in the pseudo code explain one example only, and are non-limiting.

```
function Delay(int seconds) // this function may be executed continually on viewer browser
{
  while(false) // infinite loop
  {
    CheckForChanges( ); // executing function CheckForChanges
    Wait(seconds); // function to delay by number of seconds (including fractions of
seconds)
  }
}
function CheckForChanges( )
{
  Request from
“/presentation/querypage.aspx?token=HJGDSDYGNMKLJKYFGRDERRT”; // Calls a page
which takes token, recognizes caller by the token, and returns a link from the server where the
placeholder should point to. Each viewer may have a different token.
  On return go to ResponseFromCheckForChanges; // When server finishes processing the
request, go to function ResponseFromCheckForChanges.
}
function ResponseFromCheckForChanges( )
{
  if (place holder content == response link from server) // compare if its the same
  {
    do nothing
  }
  else
  {
    place holder content = response link from server // update place holder to the current
link.
  }
}
```

In some embodiments, server 110 may contain sufficient capability for serving more than one display file sequence at a time from more than one presenter at a time. In such cases, one or more viewers at for example terminals 151-153 may log in separately for a second display sequence, while a presenter at for example file schedule controller 102 may direct the second file display sequence.

In some embodiments, server 110 may contain a software process or application capable of displaying the sequence of display files without a file schedule controller. For this automatic display mode of operation, image dispatcher 412 may for example be configured to display or serve a sequence of files or a presentation to one or more viewer terminals at a pre-determined time automatically at a predetermined pace. Alternatively each slide may be individually requested on demand as directed by one or more viewers individually or as a group in a semi-automatic display mode. Such automatic or semi-automatic display may only be enabled by the user or presenter. In some embodiments, server 110 may be configured to enable a viewer to switch between automatic and semi-automatic display modes. In some embodiments the presenter may be able to assign control of the presentation to a secondary user or presenter at a separate file schedule controller. Such a secondary presenter may not be allowed to modify the display sequence or skip individual files in the sequence. Other techniques for displaying with the presentation owner or presenter may also be used.

In some embodiments, a broader range of communications and revenue supporting applications may be allowed. These services include and are not limited to recording file sequence display sessions along with any audio overlay or commentary provided by the presenter as may be allowable by law, reuse of image sequences in whole or in part for other presentations, and other communication services known in the art. Revenue supporting applications may include and are not limited to advertisements, RSS feeds, search engines, linked download services.

In some embodiments, the viewer or recipient views information via a pre-installed application such as an Internet browser. Thus, except for administrative or display files that may be stored by the browser or operating system software (e.g., temporary display files), the images displayed by the presenter are not stored on the viewer or recipient terminal in an easily accessible manner. The display files, e.g. images or pages shown to the viewer are transient with respect to the viewer terminal, when operated normally.

Although the particular embodiments shown and described above will prove to be useful for the many distribution systems to which the present invention pertains, further modifications of the present invention will occur to persons skilled in the art. All such modifications are deemed to be within the scope and spirit of the present invention as defined by the appended claims.

What is claimed is:

1. A method comprising, at a server connected to a network:
receiving a media file comprising one or more display files;
storing the one or more display files in a media storage library stored on the server;
generating a sequence of files to display, the sequence comprising an ordered list of one or more selected display files, said one or more selected display files stored in the media storage library;
authenticating a display client on the network, said client configured for displaying a sequence of files on the server;
transmitting to the display client a pointer to the display file in the sequence of files to present.

2. The method of claim 1, comprising dividing the media file into two or more display files according to the number of display components in the media file if the media file includes two or more display components.

3. The method of claim 1, comprising receiving an indication from a control terminal of a current display file in the sequence of files to present.

4. The method of claim 1, comprising receiving a request from the display client for a pointer to the current display file in the sequence of files to present; and
transmitting to the display client the pointer to the current display file in the sequence of files to present.

5. The method of claim 1, wherein the pointer to the current display file is a hyperlink.

6. The method of claim 1 wherein said receiving, storing, and transmitting are repeated for all images in the sequence.

7. The method of claim 1, wherein the file display sequence is controlled from a first client workstation on the network.

8. The method of claim 7, wherein the first client workstation delegates control of the shared work station to a second client work station on the network.

9. The method of claim 7, wherein setting the pointer is controlled from a first client workstation on the network.

10. The method of claim 8, wherein the pointer may be set to any position in the sequence non-sequentially.

11. The method of claim 1, wherein the display client is configured for requesting transmission of a display file on the server to which the pointer is set.

12. The method of claim 5, wherein the display client is configured for requesting transmission of a display file on the server to which the pointer is set by executing a script on a web page of a web site hosted by the server.

13. A method comprising, at a display client on a network:
at a regular interval, transmitting to a server a request to transmit a pointer to a current display file;
receiving the pointer;
comparing the pointer to a currently held pointer, and, if the pointer differs from the currently held pointer, displaying a display file stored on the server based on the pointer.

14. The method of claim 13, wherein the transmitting, comparing and displaying is performed by a web browser.

15. The method of claim 12, wherein the file display sequence is controlled from a workstation separate from the display client.

16. A method for controlling a file display sequence on a remote viewer terminal from a control terminal, the method comprising:
displaying one or more images at the control terminal, the one or more images corresponding to one or more display files stored on a server;
selecting a display file; and
transmitting from the control terminal to the server an indicator to the selected display file, the server configured to send to the remote viewer terminal a pointer to the selected display file when a current display file is requested by the remote terminal.

17. The method of claim 16, wherein the display files are formatted for display in a web browser.

18. The method of claim 16, comprising
repeating said selecting for a two or more display files to create a sequence of display files; and
transmitting from the control terminal to the server a sequence of two or more indicators to the sequence of display files.

19. The method of claim 18, comprising:
receiving at the control terminal the sequence of two or more indicators;
selecting a current indicator of the sequence of two or more indicators; and
transmitting from the control terminal to the server the current indicator.

20. The method of claim 16, wherein the indicator is a file name and the pointer is a hyperlink.

21. The method of claim 16, wherein the remote viewer terminal is configured to request the current display file regularly.

22. A system comprising:
a display client on a network, said client configured for displaying a sequence of files;
a server connected to the display client via the network, the server to:
receive a media file comprising one or more display files;
store the one or more display files;
receive a file display sequence, the sequence comprising an ordered list of one or more selected display files, said one or more selected display files stored on the server;
authenticate the display client; and
sequentially transmit to the display client a series of pointers display files in the file display sequence.

23. The system of claim 22, wherein the server is configured for dividing the media file into two or more display files according to the number of display components in the media file if the media file includes two or more display components.

24. The system of claim 22, comprising a control terminal connected to the network for transmitting to the server an indication as to which display file is a current display file in the file display sequence.

25. The system of claim 22, wherein the display client is configured for requesting a pointer to the current display file.
